(19) United States
(12) Patent Application Publication
(10) Pub. No.: US 2007/0077916 A1
(43) Pub. Date: Apr. 5, 2007

(54) User authentication system and user authentication method

(75) Inventor: William H. Saito, Tokyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FORVAL TECHNOLOGY, INC., Tokyo (JP)

(21) Appl. No.: 11/540,536

(22) Filed: Oct. 2, 2006

Related U.S. Application Data
(60) Provisional application No. 60/722,989, filed on Oct. 4, 2005.

(51) Int. Cl. H04M 1/66

(52) U.S. Cl. 455/411; 713/176

(57) ABSTRACT

A user authentication system includes a user terminal, a mobile phone, a password issuing unit, and a service providing unit. When the service providing unit receives user's data on user identification information from the user terminal, if the received data on the user identification information is registered in advance, the service providing unit sends the data to the password issuing unit. The password issuing unit searches connection information data of the mobile phone corresponding to the received data in the user identification information, generates a one-time password, and sends the one-time password to the mobile phone and to the service providing unit. The mobile phone displays the received one-time password. The user terminal sends the one-time password displayed on the mobile phone to the service providing unit. When the service providing unit determines that the two one-time passwords each sent from the password issuing unit and the user terminal are identical, the service providing unit permits the access of the user via the user terminal.

### CROSS REFERENCE TO RELATED APPLICATIONS

The present application claims the benefit of Provisional Patent Application No. 60/722,989 filed on Oct. 4, 2005.

### BACKGROUND OF THE INVENTION

1. Field of the Invention

The present invention relates to a user authentication technology on the Internet, and more specifically, to a user authentication system capable of maintaining security strength and of reducing a user's load of operations necessary for login, and the user authentication method.

2. Description of the Related Art

As a representative method for conducting authentication in a system in which a user is permitted to access the system only after the user is authenticated, the method has been known in which a user enters a user name and a password registered in advance from a user terminal thereof, the user name and the password are subjected to verification in the system, and, when the user name and the password make a valid combination, the access of the user is permitted.

To ensure security, the authentication method described above is designed to make an accidental coincidence of a password difficult to happen, even if a random combination of alphabets and numerals is entered as a password. For example, a lengthy password or a complicated password with capital letters and small letters mixed therein may be used in the authentication method. Additionally or alternatively, a valid period of a password may be made short to prevent a stolen password from being misused.

Another authentication system has been also realized in which a hardware token is inserted in a USB (Universal Serial Bus) port, and an ID (Identification) stored in the hardware token is read out for authentication.

In the former authentication system, however, when a password is made complicated or is changed on a regular basis to ensure security, there has been a problem that a user may forget a password or may write a password on paper as a reminder, which could undermine security.

In the latter authentication system, the hardware token is cumbersome to use, because a user may lose the hardware token, or has to replace a battery thereof on some regular basis.

In the light of the problems described above, “SecureCall” by Third Networks Co., Ltd. (Internet searched on Aug. 16, 2005) URL: http://www.thirdnetworks.co.jp/sc/03ser02.html discloses a user authentication system in which, when a user logs in from a terminal, an authentication server calls back to a mobile phone or the like of the user via a telephone network to conduct an additional authentication, and, only when the authentication via the mobile phone as well as via the terminal is successfully conducted, the user is permitted to access the system.

In the user authentication system described in the “SecureCall”, in the meantime, a user needs to keep in mind a combination of a user ID (Identifier) and a password to be entered from a terminal, and a password to be entered from a mobile phone. Accordingly, there is also a possibility that a user may forget a password(s), making it impossible for the user to log in the system.

The present invention has been made to solve the problems described above, and an object of the present invention is to provide a user authentication system and method capable of maintaining high-level security and of reducing a user's load of operations necessary for login.

### SUMMARY OF THE INVENTION

The user authentication system according to the present invention comprises a user terminal for entering information data for user authentication; a mobile phone having a display function; a password issuing unit for generating a one-time password; and a service providing unit for providing service to the user terminal and conducting operations for user authentication, which are connected to each other. The user authentication system is characterized in that, when the user terminal obtains, from a user, user identification information for identifying this user, the user terminal sends the user's data on the user identification information to the service providing unit; and, when a one-time password displayed on the mobile phone is entered into the user terminal, the user terminal sends the one-time password to the service providing unit: when the mobile phone receives the one-time password from the password issuing unit, the mobile phone displays the one-time password: when the password issuing server in which first connection information as information concerning connection of the mobile phone related to the user identification information is stored in advance obtains the user's date on the user identification information from the service providing unit, the password issuing server searches the first connection information related to the user identification information; generates a random one-time password; sends the generated random one-time password to the service providing unit; and sends the one-time password also to the mobile phone using the first connection information: and, when the service providing unit in which all users' data on the user identification information is stored in advance receives the user's data on the user identification information from the user terminal, the service providing unit determines whether there is any data identical with the received user's data on the user identification information, in all users' data on the user identification information stored in the service providing unit or not; when there is an identical data in the user identification information, the service providing unit sends the identical data to the password issuing server; when the service providing unit receives two one-time passwords each from the user terminal and the password issuing server, the service providing unit compares the two one-time passwords; and, when the two one-time passwords are identical, the service providing unit permits the access of the user via the user terminal.

### BRIEF DESCRIPTION OF THE DRAWINGS

FIG. 1 is a schematic block diagram illustrating the user authentication system.

FIG. 2 is an example of information data contained in the user management information.

FIG. 3 is an example of information data contained in the mobile phone management information.

FIG. 4A and 4B are sequence diagrams each illustrating operations in the user authentication system according to a first embodiment.

FIG. 5 is a view showing an example of a user ID entry screen.

FIG. 6 is a view showing an example of a password entry screen.

FIG. 7A, 7B and 7C are sequence diagrams each illustrating operations in the user authentication system according to the second embodiment.

### DETAILED DESCRIPTION OF EXEMPLARY EMBODIMENTS

Embodiments of the present invention are described next in detail with reference to the accompanying drawings.

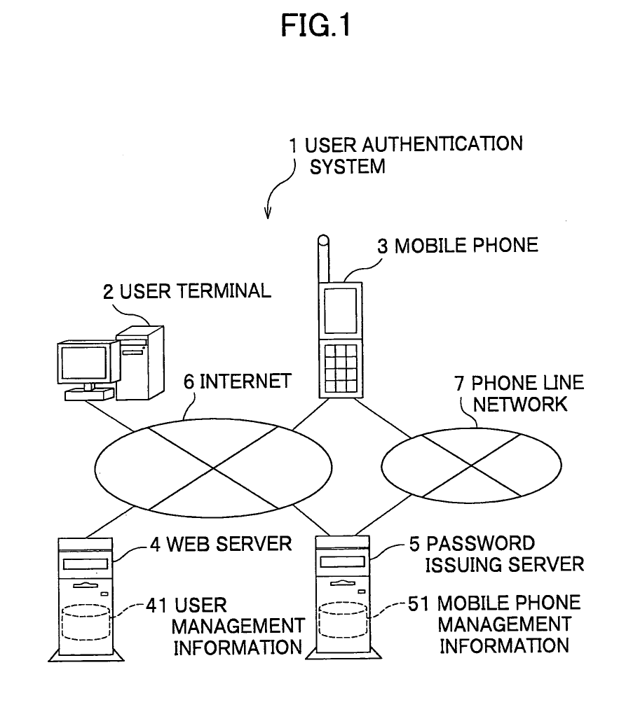

FIG. 1 is a schematic block diagram according to a first embodiment. As shown in FIG. 1, a user authentication system 1 according to this embodiment comprises a user terminal 2 to be used by a user; a mobile phone to be used by the user 3; a Web server 4 to which the user wants to log in; and a password issuing server 5 for mediating operations on authentication between the user terminal 2 and the Web server 4, which are connected to each other via the Internet 6.

In addition, the mobile phone 3 and the password issuing server 5 are also connected to each other via a telephone network 7.

(User Terminal)

The user terminal 2 is a terminal unit used by a user to connect to the Internet 6 to receive service, and comprises a RAM (Random Access Memory), a ROM (Read Only Memory) and a hard disk drive; a CPU (Central Processing Unit); a mouse and a keyboard; a display; and a LAN (Local Area Network) card. The user terminal 2 is embodied by, for example, a personal computer.

Besides an OS (Operating System), a Web browser software is installed in the ROM and/or the hard disk of the user terminal 2, and, when such software is deployed in the RAM and executed by a CPU, the user terminal 2 operates as a terminal unit connectable to the Internet 6.

(Mobile Phone)

The mobile phone 3 is used for obtaining a one-time password, and comprises a RAM and a ROM, a CPU, a numeric keypad, a display, and a communication circuit.

The ROM in the mobile phone 3 stores therein a program for exercising centralized control over functions of the mobile phone 3, image data used in the mobile phone 3, and a browser program for Web browsing. Operation information generated by entering data from the numeric keypad is input into the CPU, based on which the CPU generates image information data to output the same on the display.

The ROM in the mobile phone 3 according to this embodiment further stores therein a program for sending and receiving a short message. The short message service provided by a mobile phone company makes it possible for the mobile phone 3 to send and receive a short message via the telephone network 7 using the phone number of the mobile phone 3 as an address for the short message.

In this embodiment, it is to be noted that, to simplify the description, FIG. 1 shows that the mobile phone 3 is seemingly connected directly to the Internet 6, however, the mobile phone 3 is actually connected to the telephone network 7, and, via a gateway not shown and connected to the telephone network 7, the mobile phone 3 is finally connected to the Internet 6.

(Web Server)

The Web server 4 is a unit for providing a user with service on the Internet 6, and comprises a RAM, a ROM and a hard disk; a CPU; and a LAN card. The Web server 4 is embodied by, for example, a server computer.

The hard disk drive in the Web server 4 stores therein a service program for providing service, a user authentication program for conducting user authentication using a one-time password, and user management information 41 with information data concerning users contained therein.

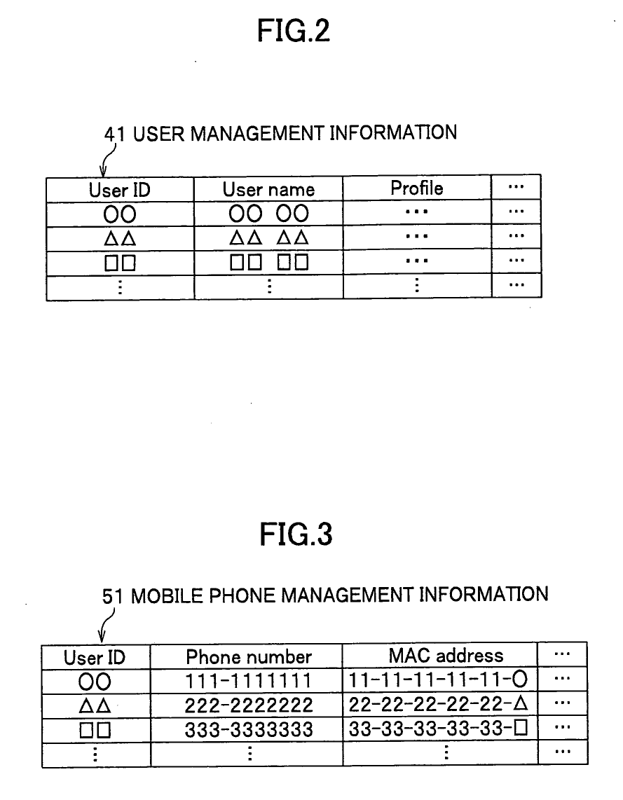

FIG. 2 is a table showing an example of information data contained in the user management information 41. As shown in FIG. 2, the user management information 41 stores therein information data concerning the users who can use the service provided by the Web server 4. The user management information 41 contains therein a user name, a user profile and the like each associated with a user ID unique to each user.

Data in the user management information 41 is registered in advance by, for example, an administrator of the Web server 4, before a user uses the user authentication system 1.

The Web server 4 herein corresponds to the service providing unit described in Claims. The user ID corresponds to the user identification information described in Claims.

(Password Issuing Server)

The password issuing server 5 is a unit like the Web server 4, and comprises a RAM, a ROM and a hard disk; a CPU; and a LAN card. The password issuing server 5 is embodied by, for example, a server computer.

The hard disk drive in the password issuing server 5 stores therein mobile phone management information 51 containing information data for identifying the mobile phone 3 used by a user, and a password issuing program for issuing a random one-time password. The password issuing program issues a one-time password and transmits the one-time password to the mobile phone 3 via the telephone network 7.

FIG. 3 is a table showing an example of information data contained in the mobile phone management information 51. As shown in FIG. 3, the mobile phone management information 51 contains a phone number of the mobile phone 3, a MAC (Media Access Control) address, or the like each associated with a user ID unique to each user of the mobile phone 3. In addition, the mobile phone management information 51 may contain therein an ESN (Electronic Serial Number) of the mobile phone 3.

Data in the mobile phone management information 51 is registered in advance by, for example, an administrator of the password issuing server 5, before a user uses the user authentication system 1. The password issuing server 5 corresponds to the password issuing unit described in Claims. The phone number of the mobile phone 3 corresponds to the first connection information described in Claims.

In the user authentication system 1 according to this embodiment, it is to be noted that communications between each component via the Internet 6 are performed by means of, for example, an encrypted communication using the SSL (Secure Socket Layer).

### First Embodiment

Two embodiments of the user authentication method carried out in the above-mentioned user authentication system 1 are described below.

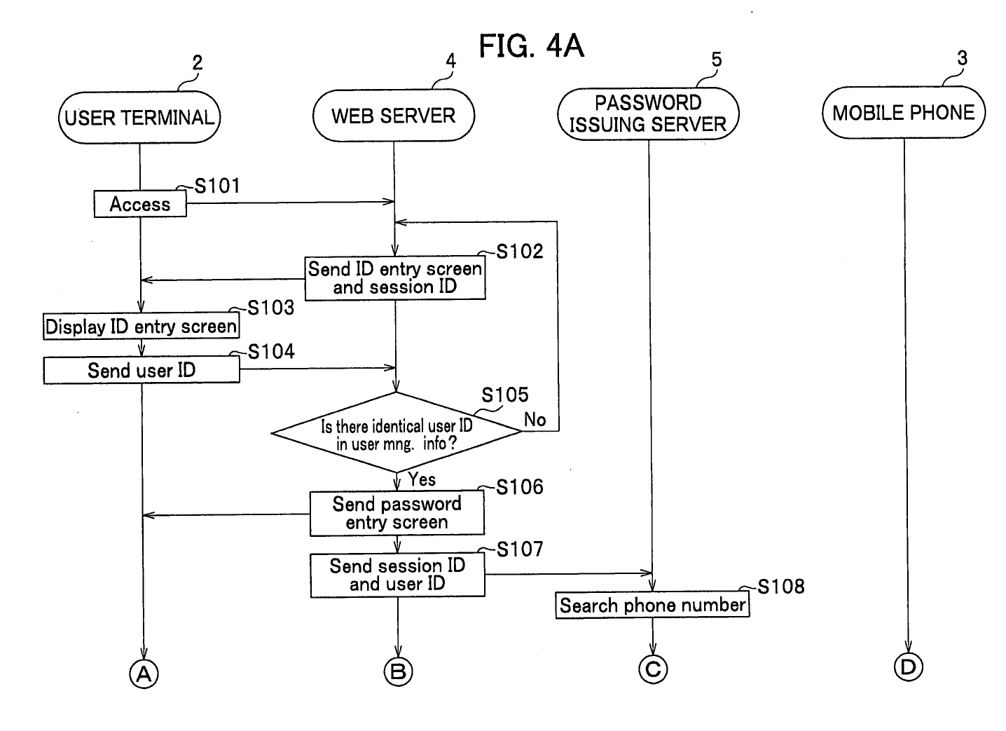

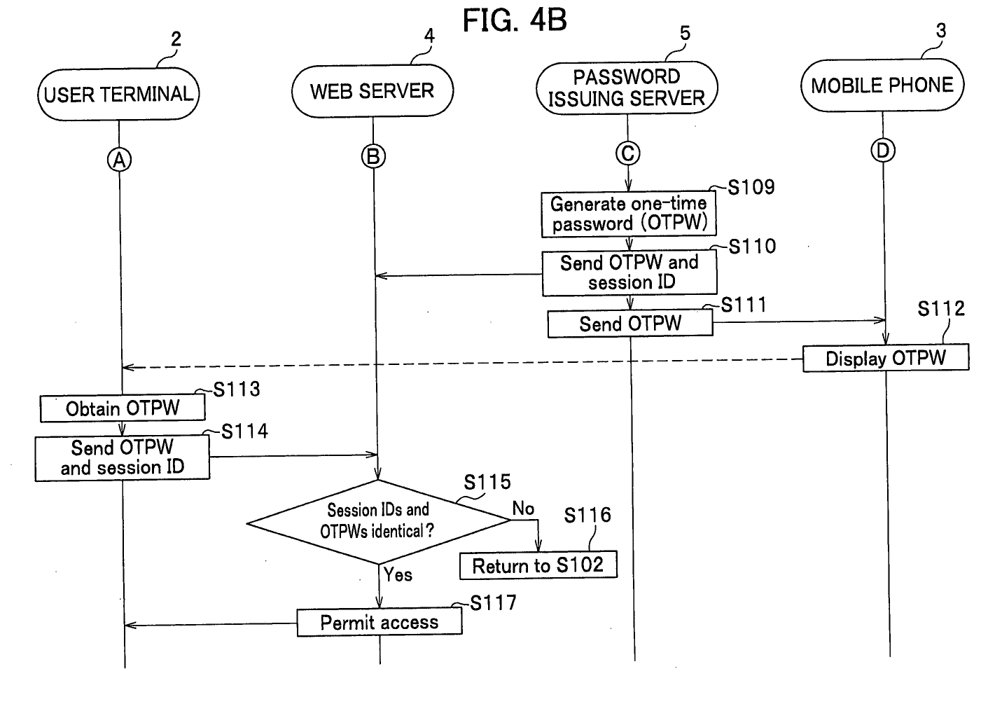

First, the user authentication method according to a first embodiment is described in detail with reference to FIG. 4A and FIG. 4B, each of which is a sequence diagram illustrating operations in the user authentication system 1.

In this embodiment, authentication of a user who enters a user ID is conducted by verifying a one-time password entered by the same user.

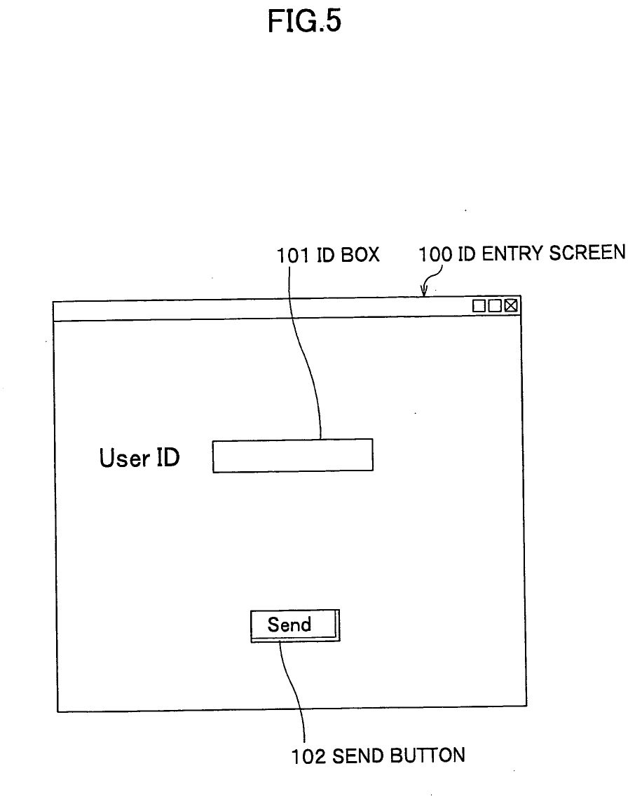

First, a user who wants to use service of the Web server 4 accesses the Web server 4 from the user terminal 2 (step S101). In response to this operation, the Web server 4 sends an ID entry screen and a session ID for identifying a session carried out between the user terminal 2 and the Web server 4 to the user terminal 2 (step S102). Herein, FIG. 5 is an example of an ID entry screen sent by the Web server 4. The ID entry screen 100 shown in FIG. 5 includes an ID box 101 into which a user enters a user ID assigned thereto, and a send button 102 on which a user clicks to send the user ID entered into the ID box 101 to the Web server 4.

Next, the user terminal 2 displays the received ID entry screen 100 on a display thereof (step S103). The user then enters the user's own ID into the ID box 101 on the ID entry screen, and clicks the send button. With this operation, the user terminal 2 obtains the user ID, and sends the obtained user ID to the Web server 4 (step S104).

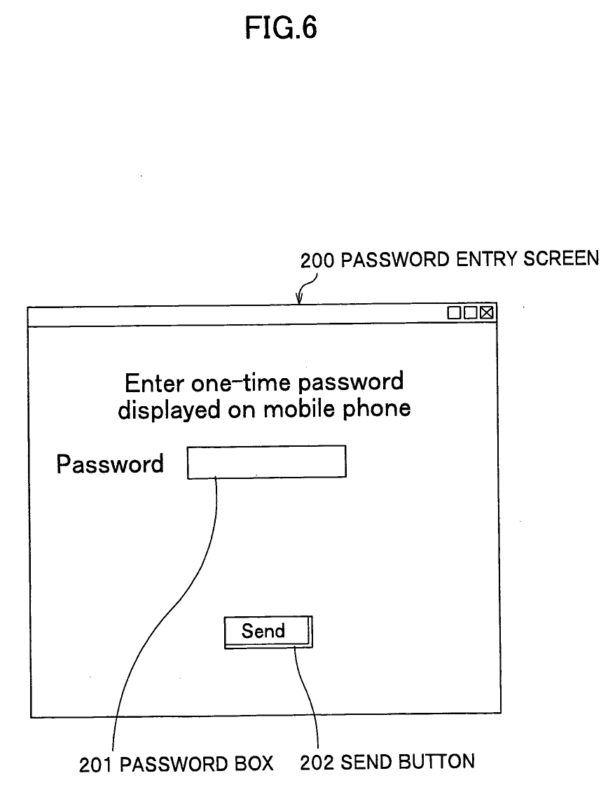

When the Web server 4 receives the user ID, the Web server 4 references the user management information 41 to determine whether there is any user ID identical with the received user ID in the user management information 41 or not (step S105). When there is no identical user ID (‘No’ in step S105), the process returns to step S102, and the Web server 4 prompts the user to reenter the user ID. When there is an identical user ID (‘Yes’ in step S105), the Web server 4 sends a password entry screen to the user terminal 2 to prompt the user to enter a one-time password (step S106). Herein, FIG. 6 is an example of a password entry screen. As shown in FIG. 6, a password entry screen 200 includes a password box 201 into which a user enters a one-time password displayed on the display of the mobile phone 3 according to the steps to be hereinafter described, and a send button 202 on which the user clicks to send the one-time password entered into the password box 201 to the Web server 4.

The Web server 4 then sends a session ID identifying a session carried out between the user terminal 2 and the Web server 4 and the received user ID to the password issuing server 5 (step S107).

The password issuing server 5 then retrieves the phone number of the mobile phone 3 corresponding to the user ID in the mobile phone management information 51, using the received user ID as key information data (step S108).

Next, moving to FIG. 4B, the password issuing server 5 randomly generates a one-time password (step S109), and sends the one-time password and the session ID received in step S107 to the Web server 4 (step S110).

The password issuing server 5 sends the one-time password generated in step S109 to the mobile phone 3 (step S111). In this step, it is preferable that the one-time password is sent to the mobile phone 3 using the short message service provided by a mobile phone company via the telephone network 7. This is because the phone number contained in the cookie data can be checked. Alternatively, the same effect can be achieved in the configuration in which the password issuing server 5 is provided with a voice synthesizer to call back to the mobile phone 3 via the telephone network 7 to send a one-time password by means of synthesized voice.

It is also possible that a one-time password is sent to the mobile phone 3 via the Internet 6.

Next, the mobile phone 3 displays the received one-time password on the display thereof (step S112). The user then enters the one-time password displayed on the display of the mobile phone 3, into the password box 201 on the password entry screen 200 shown in FIG. 6, and clicks the send button 202. With this operation, the user terminal 2 obtains the one-time password (step S113), and sends this one-time password and the session ID of the Web server 4 obtained in step S102 to the Web server 4 (step S114).

When the Web server 4 receives the one-time password and the session ID, the Web server 4 compares the one-time password and the session ID sent from the password issuing server 5 in step S110, with the one-time password and the session ID sent from the user terminal 2 in step S114 to determine whether the one-time passwords and the session IDs are identical with each other or not (step S115).

As a result of determination in step S115, when the one-time passwords and the session IDs are not identical (‘No’ in step S115), the process returns to step S102 (step S106), and the authentication is attempted again.

On the other hand, when the one-time passwords and the session IDs are identical (‘Yes’ in step S115), the Web server 4 determines that the authentication is successfully conducted, and permits the access of the user via the user terminal 2 (step S117). Then the user can receive a desired service from the Web server 4 via the user terminal 2.

As described above, in the user authentication method according to this embodiment, the one-time password issued by the password issuing server 5 is sent to the mobile phone 3 registered in advance. Then operations for authentication of the user are conducted in the Web server 4 using the one-time password. With this operation, even when an unauthorized third person attempts access to the Web server 4, the person cannot enter a valid password, and therefore, the security can be ensured at a level as high as that obtained when a hardware token is employed. Additionally, the operations for authentication can be conducted by entering a one-time password displayed on the display of the mobile phone 3, onto the password entry screen 200, which avoids the need of a user to keep a complicated password in mind, and significantly reduces the user's load of operations necessary for login.

### Second Embodiment

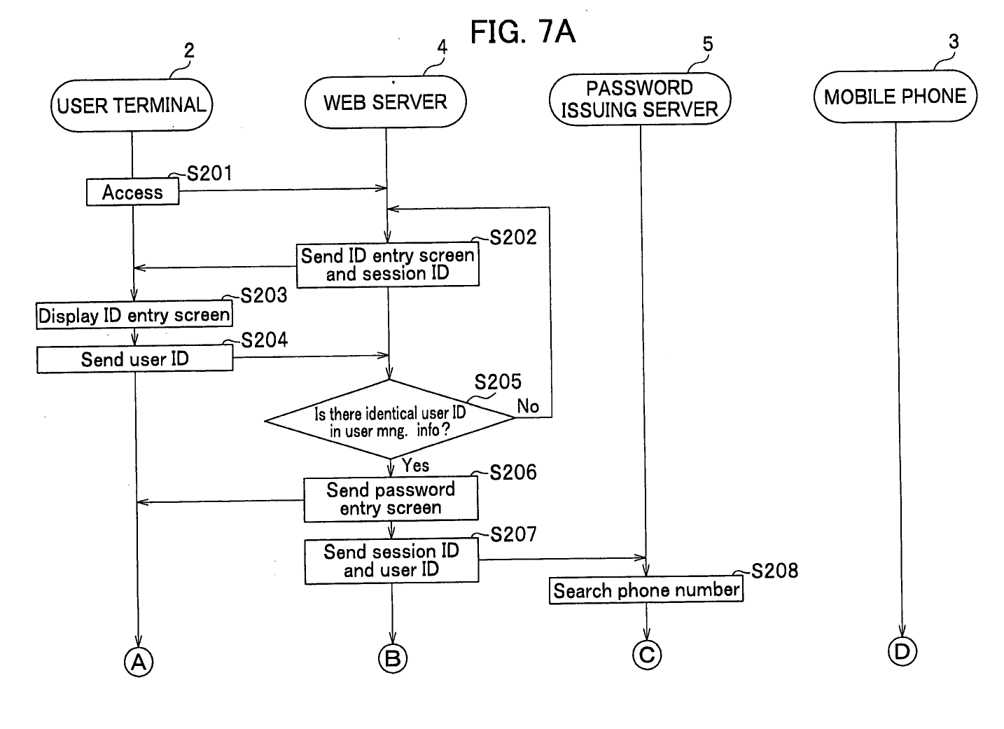

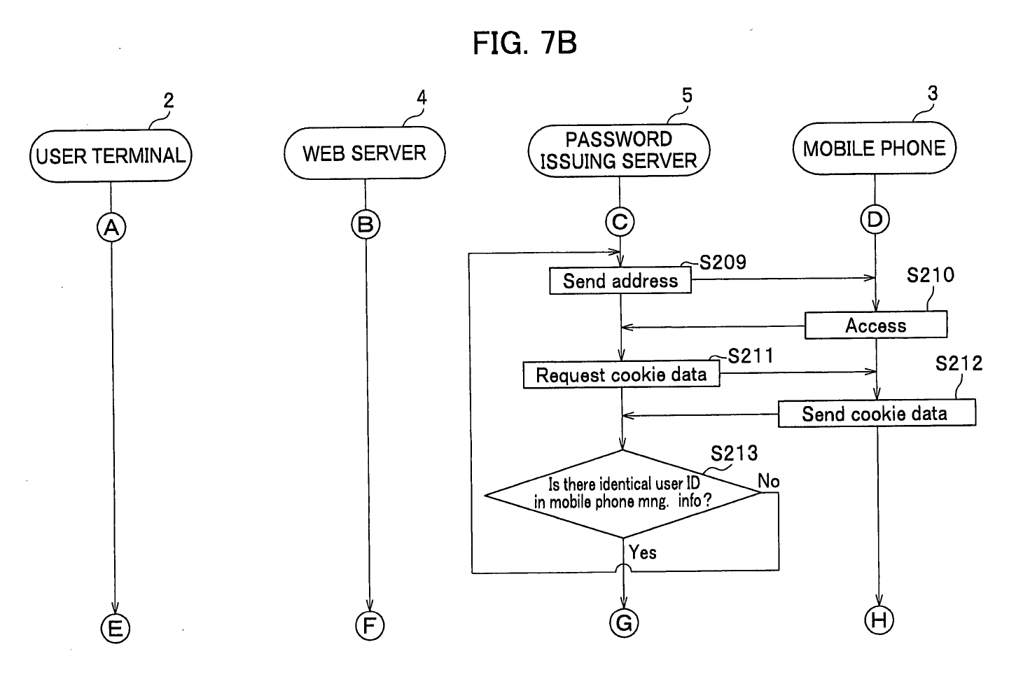

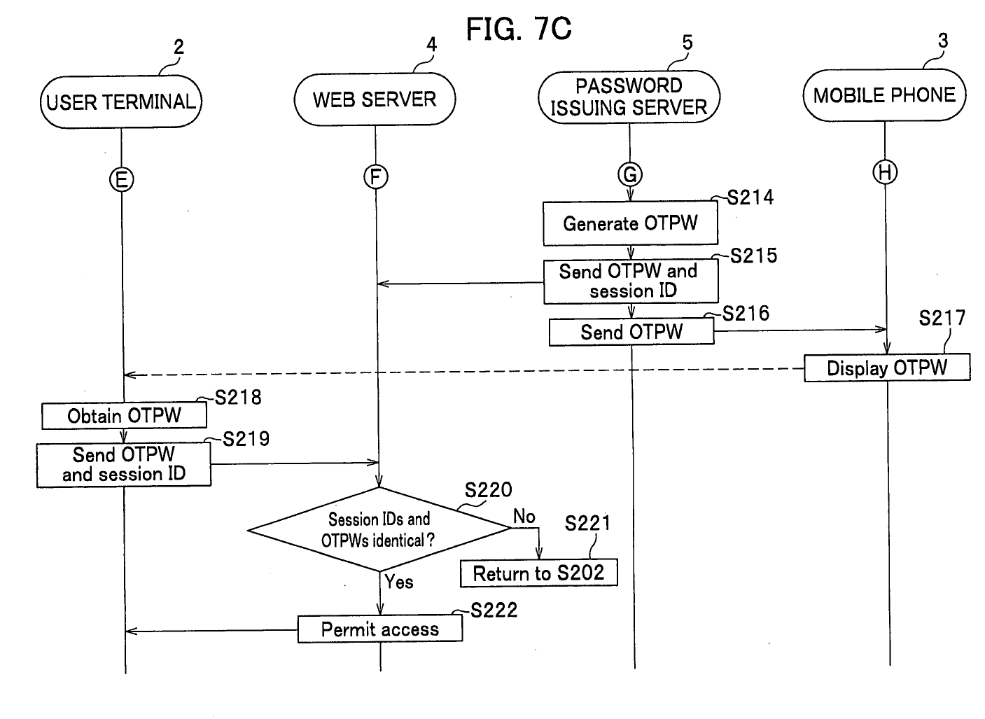

Next, the user authentication method according to a second embodiment is described in detail with reference to FIG. 7A through FIG. 7C, each of which is a sequence diagram illustrating operations in the user authentication system 1.

In this embodiment, an address and a one-time password of the password issuing server 5 are sent to the mobile phone 3 using the short message service to conduct operations for authentication between the mobile phone 3 and the password issuing server 5. Then the one-time password is subjected to verification in the Web server 4 to thereby conduct the user authentication.

In this embodiment, operations in step S201 through step S208 shown in FIG. 7A are the same as those in step S101 through step S108 (See FIG. 4A), description of which is omitted accordingly.

Next, moving to FIG. 7B, the password issuing server 5 having retrieved the phone number of the mobile phone 3 in step S208 sends the address thereof to the mobile phone 3 using the retrieved phone number through the short message service (step S209)

When the mobile phone 3 receives the address of the password issuing server 5, the mobile phone 3 accesses the password issuing server 5 using the address (step S210). It is to be noted that the address of the password issuing server 5 corresponds to the second connection information described in Claims.

When the password issuing server 5 is accessed by the mobile phone 3, the password issuing server 5 requests the mobile phone 3 to send cookie data (step S211).

When the mobile phone 3 is requested to send the cookie data, the mobile phone 3 sends the cookie data to the password issuing server 5 (step S212). The cookie data sent by the mobile phone 3 herein contains the MAC address, and the phone number and the ESN of the mobile phone 3.

When the password issuing server 5 receives the cookie data from the mobile phone 3, the password issuing server 5 verifies the cookie data with the MAC address, the phone number and the ESN of the mobile phone 3 registered in the mobile phone management information 51 to determine whether there is any identical user ID in the mobile phone management information 51 or not (step S213).

When there is no identical user ID in the mobile phone management information 51 (‘No’ in step S213), the process returns to step S209 so that the password issuing server 5 can receive possible access from other mobile phone 3 registered in the mobile phone management information 51.

Then, moving to FIG. 7C, when there is a corresponding user ID in the mobile phone management information 51 (‘Yes’ in step S213), the password issuing server 5 randomly generates a one-time password (step S214), and sends the one-time password and the session ID of the Web server 4 received in step S207 to the Web server 4 (step S215).

The password issuing server 5 then sends the one-time password generated in step S214 to the mobile phone 3 (step S216). In this step, it is preferable that the password issuing server 5 sends the one-time password to the mobile phone 3 using the short message service provided by a mobile phone company via the telephone network 7.

Next, the mobile phone 3 displays the received one-time password on the display thereof. The user then enters the one-time password displayed on the display of the mobile phone 3, into the password box 201 on the password entry screen 200 shown in FIG. 6, and clicks the send button 202. With this operation, the user terminal 2 obtains the one-time password (step S218), and sends this one-time password and the session ID of the Web server 4 obtained in step S202 to the Web server 4 (step S219).

When the Web server 4 receives the one-time password and the session ID, the Web server 4 references the user management information 41; identifies the user from the obtained user ID; and compares the one-time password and the session ID sent from the password issuing server 5 in step S215, with the one-time password and the session ID sent from the user terminal 2 in step S219 to determine whether the one-time passwords and the session IDs are identical or not (step S220).

As a result of determination in step S220, when the one-time passwords and the session IDs are not identical (‘No’ in step S220), the Web server 4 determines that an error occurs, and the process returns to step S202 (step S221), so that the authentication is to be attempted again.

When the one-time passwords and the session IDs are identical (‘Yes’ in step S220), the Web server 4 determines that the authentication is successfully conducted, and permits the access of the user via the user terminal 2 (step S222). Thus the user can receive a desired service from the Web server 4 via the user terminal 2.

As described above, in the user authentication method according to this embodiment, the password issuing server 5 obtains the cookie data from the mobile phone 3 to determine whether the mobile phone 3 is registered in advance or not, namely, the identification of the mobile phone 3 to which a one-time password is to be sent is confirmed, ensuring high-level security.

In addition, the authentication can be conducted by verifying the one-time password issued by the password issuing server 5, so that the user needs to keep only a user ID in mind, which significantly reduces the user's load of operations necessary for authentication.

In this embodiment, a case is assumed in which each of the programs for making the Web server 4 and the password issuing server 5 operate is stored in a hard disk. Those programs are read from a CD-ROM with the programs stored therein, and are then installed in the hard disk. Besides the CD-ROM, the programs may be installed from a recording medium with the programs stored therein in a computer-readable manner, such as a flexible disk and an IC card. Further, the programs may be downloaded via a communication line.

The embodiments of the present invention are described above, however, the present invention is not limited to the above-mentioned embodiments. Various changes can be made within a range not departing from the gist of the present invention.

For example, in the embodiments above, the Web server 4 and the password issuing server 5 are separate servers, however, the configuration is allowable in which the Web server 4 and the password issuing server 5 are integrated into one server, providing the Web server 4 with the function of the password issuing server 5.

Additionally, for example, in a case where even higher-level of security is required, the present invention can be carried out in combination with the authentication using a password(s) according to the conventional technology.

1. A user authentication system comprising: a user terminal for entering information data on user authentication; a mobile phone having a display function; a password issuing unit for generating a one-time password; and a service providing unit for providing service to the user terminal and conducting operations for user authentication, which are connected to each other,
wherein, when the user terminal obtains, from a user, data on user identification information for identifying the user, the user terminal sends the user's data on the user identification information to the service providing unit; and, when a one-time password displayed on the mobile phone is entered into the user terminal, the user terminal sends the one-time password to the service providing unit,
wherein, when the mobile phone receives the one-time password from the password issuing unit, the mobile phone displays the one-time password,
wherein, when the password issuing unit in which first connection information which is information concerning connection of the mobile phone related to the user identification information is stored in advance obtains the user's data on the user identification information from the service providing unit, the password issuing unit searches the first connection information related to the user's data on the user identification information; generates a random one-time password; sends the one-time password to the service providing unit; and sends the one-time password to the mobile phone using the first connection information; and
wherein, when the service providing unit in which all users' data on the user identification information is stored in advance receives the user's data on the user identification information from the user terminal, the service providing unit determines whether there is any data identical with the received user's data on the user identification information, in all users' data on the user identification information stored in the service providing unit or not; when there is identical data in the user identification information, the service providing unit sends the identical data to the password issuing server; when the service providing unit receives two one-time passwords each from the user terminal and the password issuing server, the service providing unit compares the two one-time passwords; and, when the two one-time passwords are identical, the service providing unit permits the access of the user via the user terminal.

2. A user authentication system comprising: a user terminal for entering information data on user authentication; a mobile phone having a browsing function; a password issuing unit for generating a one-time password; and a service providing unit for providing service to the user terminal and conducting operations for user authentication, which are connected to each other,
wherein, when the user terminal obtains, from a user, data on user identification information for identifying the user, the user terminal sends the user's data on the user identification information to the service providing unit; and, when a one-time password displayed on the mobile phone is entered into the user terminal, the user terminal sends the one-time password to the service providing unit,
wherein, when the password issuing unit in which first connection information as information concerning connection of the mobile phone related to the user identification information is stored in advance obtains the user's data on the user identification information from the service providing unit, the password issuing unit searches the first connection information related to the user's data on the user identification information; the password issuing unit sends second connection information as information concerning connection of the password issuing unit to the mobile phone using the obtained user's data on the first connection information; when the password issuing unit is accessed by the mobile phone, the password issuing unit generates a random one-time password; the password issuing unit sends the one-time password to the service providing unit; and the password issuing unit sends the one-time password to the mobile phone,
wherein, when the mobile phone receives the second connection information from the password issuing unit, the mobile phone accesses the password issuing unit using the second connection information; and, when the mobile phone obtains the one-time password from the password issuing unit, the mobile phone displays the one-time password, and
wherein, when the service providing unit in which all users' data on the user identification information is stored in advance receives the user's data on the user identification information from the user terminal, the service providing unit determines whether there is any data identical with the received user's data on the user identification information, in all users' data on the user identification information stored in the service providing unit or not; when there is an identical data in the user identification information, the service providing unit sends the identical data to the password issuing server; when the service providing unit receives two one-time passwords each from the user terminal and the password issuing server, the service providing unit compares the two one-time passwords; and, when the two one-time passwords are identical, the service providing unit permits the access of the user via the user terminal.

3. The user authentication system according to claim 2, wherein the mobile phone stores therein data on mobile phone identification information for identifying this mobile phone, and
wherein when the password issuing unit in which all users' data on the mobile phone identification information related to the user identification information is stored in advance is accessed by the mobile phone, the password issuing unit requests the mobile phone to send the user's data on the mobile phone identification information; when the password issuing unit receives the user's data on the mobile phone identification information from the mobile phone in response to the request, the password issuing unit compares the received the user's data on the mobile phone identification information, with all users' data on the mobile phone identification information stored in the password issuing unit; and, when there is an identical data in the mobile phone identification information, the password issuing unit sends the one-time password to the mobile phone.

4. The user authentication system according to claim 3,
wherein the mobile phone identification information is the data of the phone number of the mobile phone, and
wherein, when the password issuing unit sends the one-time password to the mobile phone, the password issuing unit sends the one-time password via a telephone network.

5. A user authentication method in a user authentication system comprising: a user terminal for entering information data for user authentication; a mobile phone having a display function; a password issuing unit for generating a one-time password; and a service providing unit for providing service to the user terminal and conducting operations for user authentication, which are connected to each other, the user authentication method comprising:
(a) the step in which, when the user terminal obtains, from a user, data on user identification information for identifying the user, the user terminal sends the user's data on the user identification information to the service providing unit,
(b) the step in which, when the service providing unit in which all users' data on the user identification information is stored in advance receives the user's data on the user identification information from the user terminal, the service providing unit determines whether there is any data identical with the received user's data on the user identification information, in all users' data on the user identification information stored in the service providing unit or not; and, when there is an identical data in the user identification information, the service providing unit sends the identical data to the password issuing unit,
(c) the step in which, when the password issuing unit in which first connection information as information concerning connection of the mobile phone related to the user identification information is stored in advance obtains the user's data on the user identification information from the service providing unit, the password issuing unit searches the first connection information related to the user identification information; generates a random one-time password; sends the one-time password to the service providing unit; and sends the one-time password to the mobile phone using the first connection information,
(d) the step in which, when the mobile phone receives the one-time password from the password issuing unit, the mobile phone displays the received one-time password,
(e) the step in which, when the one-time password displayed on the mobile phone is entered into the user terminal, the user terminal sends the one-time password to the service providing unit, and
(f) the step in which, when the service providing unit receives two one-time passwords each from the user terminal and the password issuing unit, the service providing unit compares the two one-time passwords; and, when the two one-time passwords are identical, the service providing unit permits the access of the user via the user terminal.

6. A user authentication method in a user authentication system comprising: a user terminal for entering information data for user authentication; a mobile phone having a display function; a password issuing unit for generating a one-time password; and a service providing unit for providing service to the user terminal and conducting operations for user authentication, which are connected to each other, the user authentication method comprising:
(a) the step in which, when the user terminal obtains, from a user, data on user identification information for identifying the user, the user terminal sends the user's data on the user identification information to the service providing unit,
(b) the step in which, when the service providing unit in which all users' data on the user identification information is stored in advance receives the user's data on the user identification information from the user terminal, the service providing unit determines whether there is any data identical with the received user's data on the user identification information, in all users' data on the user identification information stored in the service providing unit, or not; and, when there is an identical data in the user identification information, the service providing unit sends the identical data to the password issuing unit,
(c) the step, when the password issuing unit in which all user's data on first connection information as information concerning connection of the mobile phone related to the user identification information is stored in advance obtains the user's data on the user identification information from the service providing unit, the password issuing unit searches the first connection information related to the user identification information; and the password issuing unit sends the obtained user's data on second connection information as information concerning connection of the password issuing unit to the mobile phone using the first connection information,
(d) the step in which, when the mobile phone receives the user's data on the second connection information from the password issuing unit, the mobile phone accesses the password issuing unit using the user's data on the second connection information,
(e) the step in which, when the password issuing unit is accessed by the mobile phone, the password issuing unit generates a random one-time password; sends the one-time password to the service providing unit; and sends the one-time password to the mobile phone,
(f) the step in which, when the mobile phone receives the one-time password from the password issuing unit, the mobile phone displays the received one-time password,
(g) the step in which, when the one-time password displayed on the mobile phone is entered into the user terminal, the user terminal sends the one-time password to the service providing unit, and
(h) the step in which, when the service providing unit receives two one-time passwords each from the user terminal and the password issuing unit, the service providing unit compares the two one-time passwords; and, when the two one-time passwords are identical, the service providing unit permits the access of the user via the user terminal.

7. The user authentication method according to claim 6,
wherein the mobile phone stores therein data on mobile phone identification information for identifying this mobile phone, and the password issuing unit stores therein in advance all users' data on the mobile phone identification information, and
wherein, in the step (e), the password issuing unit requests the mobile phone attempting the access to send the user's data on the mobile phone identification information; when the password issuing unit receives the user's data on the mobile phone identification information from the mobile phone in response to the request, the password issuing unit compares the received user's data on the mobile phone identification information, with all users' data on the mobile phone identification information stored in the password issuing unit; and, if there is an identical data in the mobile phone identification information, the password issuing unit sends the one-time password to the service providing unit and also to the mobile phone.

8. The user authentication method according to claim 7,
wherein the mobile phone identification information is information data of the phone number of the mobile phone, and
wherein, in the step (e), when the password issuing unit sends the one-time password to the mobile phone, the password issuing unit sends the one-time password via a telephone network.
